(19) United States
(12) Patent Application Publication
(10) Pub. No.: US 2013/0081127 A1
(43) Pub. Date: Mar. 28, 2013

(54) SMART CARD AND COMMUNICATION METHOD THEREOF

(71) Applicant: Chao-Chin CHEN, Hsinchu City (TW)

(72) Inventor: Chao-Chin CHEN, Hsinchu City (TW)

(73) Assignee: AniCa Corporation, New Taipei City (TW)

(21) Appl. No.: 13/549,115

(22) Filed: Jul. 13, 2012

(30) Foreign Application Priority Data
Sep. 26, 2011 (TW) 100134590

(51) Int. Cl. H04W 12/08

(52) U.S. Cl. 726/9

(57) ABSTRACT

A smart card and a communication method thereof are provided. The smart card comprises a flexible electronic system and a card body. The flexible electronic system comprises a display circuit, a communication interface, a security module, code generator and a flexible display. The communication interface is used for communicating with a reader. The security module is used for transmitting security verification information to the reader. The code generator is electrically connected to the security module and used for generating a code. The flexible display is connected to the display circuit and used for displaying the code. The card body encapsulates the flexible electronic system. After an input device receives the inputted code, the reader transmits the inputted code and the security verification information to the confirmation server to confirm whether the inputted code and the security verification information are correct.

This application claims the benefit of Taiwan application Serial No. 100134590, filed Sep. 26, 2011, the subject matter of which is incorporated herein by reference.

### BACKGROUND OF THE INVENTION

1. Field of the Invention

The invention relates in general to a smart card and a communication method thereof, and more particularly to a smart card capable of avoiding unexpected sensing operation and a communication method thereof.

2. Description of the Related Art

Along with the advance in technology, many transactions and payments are done with a conventional integrated circuit (IC) card such as credit card, bank card and telephone card. Based on the type of communication interface, the commonly used IC cards are divided into contact mode, contactless mode and dual interface mode card.

A transaction is completed once the IC card is sensed by a reader. Thus, if an IC card is erroneously sensed by a reader, an unexpected transaction may occur and may end up with transaction disputes and require subsequent processing procedures.

### SUMMARY OF THE INVENTION

The invention is directed to a smart card and a communication method thereof capable of avoiding the smart card being erroneously sensed by the reader so as to perform an unexpected communication.

According to an embodiment of the present invention, a smart card is provided. The smart card comprises a flexible electronic system and a card body. The flexible electronic system comprises a display circuit, a communication interface, a security module, a code generator and a flexible display. The communication interface is for communicating with a reader. The security module transmits security verification information to the reader through the communication interface. The code generator is electrically connected to the security module and used for generating a code. The flexible display is connected to the display circuit and used for displaying the code. The card body encapsulates the flexible electronic system. After an input device receives an inputted code, the reader transmits the inputted code and the security verification information to a confirmation server to confirm whether the inputted code and the security verification information are correct.

According to an embodiment of the present invention, a smart card is provided. The smart card comprises a flexible electronic system, a card body and an input device. The flexible electronic system comprises a wireless communication interface and a security module. The wireless communication interface is for performing wireless communication with a reader. The security module is used for transmitting security verification information to the reader through the wireless communication interface. The card body encapsulates the flexible electronic system. The input device is electrically connected to the flexible electronic system. After the input device is triggered, the security module is used for transmitting the security verification information to the reader, which then transmits the security verification information to a confirmation server to confirm whether the security verification information is correct.

According to an embodiment of the present invention, a communication method of a smart card is provided. The communication method comprises the following steps. A communication between a smart card and a reader is performed. The smart card generates a code. The smart card displays the code. An input device electrically connected to the reader receives the displayed code. The smart card transmits security verification information to the reader. The reader transmits the inputted code to a confirmation server to confirm whether the inputted code is correct. The smart card transmits the security verification information to the reader. The reader transmits the security verification information to the confirmation server to confirm whether the inputted code and the security verification information are correct.

According to an embodiment of the present invention, a communication method of a smart card is provided. The communication method comprises the following steps. A wireless communication between a smart card and a reader is performed. After an input device of the smart card is triggered, the smart card transmits security verification information to the reader, which then transmits the security verification information to a confirmation server to confirm whether the security verification information is correct.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an external view of a smart card according to an embodiment of the invention;

FIG. 2 shows a function block diagram of the smart card of FIG. 1;

FIG. 3 shows an external view of a smart card according to another embodiment of the invention;

FIG. 4 shows a function block diagram of the smart card of FIG. 3;

FIG. 5 shows a flowchart of a communication method of a smart card according to an embodiment of the invention; and

FIG. 6 shows a flowchart of a communication method of a smart card according to another embodiment of the invention.

### DETAILED DESCRIPTION OF THE INVENTION

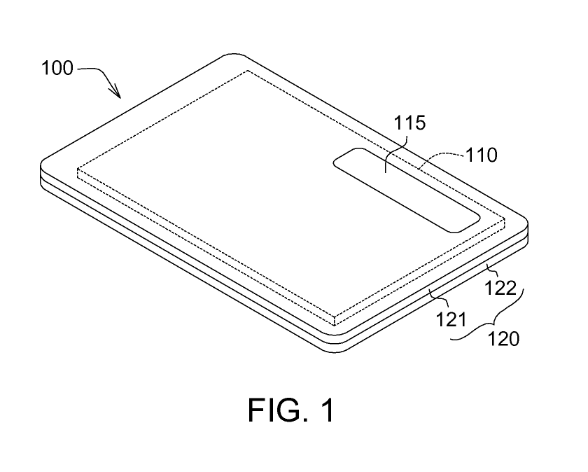

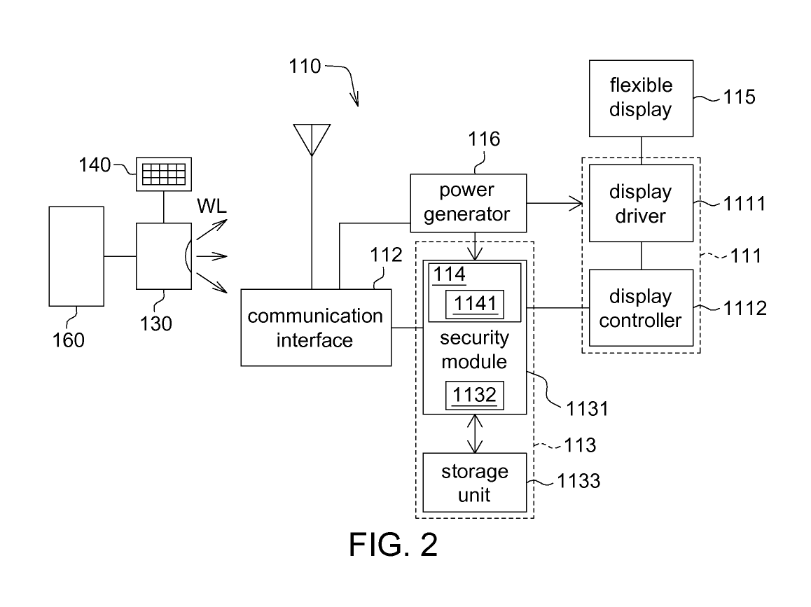

Referring to FIGS. 1 and 2. FIG. 1 shows an external view of a smart card according to an embodiment of the invention. FIG. 2 shows a function block diagram of the smart card of FIG. 1.

As indicated in FIG. 1, the smart card 100 is such as an integrated circuit (IC) card. Also, the smart card 100 may have other functions. For example, the smart card 100 may be used in stored value card, code generator card, membership card, VIP card, access card, electronic key, passport, ID card, label, bank card, credit card, advertisement card, entertainment card, name card, card type computer, card type calculator, card type e-book, card type game station or bio-signal detection card. Examples of stored value cards include electronic purse, point card, transport stored value card, telephone card, cash card or transaction card. Examples of transport cards include transport stored value card, transport par value information card or ticket card. Examples of labels include price label or security label.

As indicated in FIG. 2, the smart card 100 comprises a flexible electronic system 110 and a card body 120. The flexible electronic system 110 comprises a display circuit 111, a communication interface 112, a security module 1131, a code generator 114 and a flexible display 115. The communication interface 112 is for communicating with the reader 130. The reader 130 is such as an external reader.

The communication interface 112 may be realized by a wireless communication module or a cabled communication interface. The cabled communication interface is such as an electrical pin. In the present embodiment, the communication interface 112 is exemplified by a wireless communication module. The wireless communication module may communicate with the reader 130 by using various wireless communication technologies. The communication interface 112 is used for transmitting various information of the smart card 100 to external devices (such as the reader 130) or receiving external information. That is, the smart card 100 may transmit information of internal elements to external devices, and external information may be received through the communication interface 112 and then transmitted to the internal elements of the smart card 100.

The security module 1131 is used for transmitting the security verification information 1132 to the reader 130 to verify transaction security. The security verification information 1132 is such as card number, transaction time, verification code and/or data configured during application/approval of the card.

The flexible electronic system 110 further comprises a smart card IC 113. The smart card IC 113 comprises a security module 1131 and a storage unit 1133. The data stored in the storage unit 1133 can be accessed after security verification is successful.

The smart card IC 113 is realized by such as contact mode, contactless mode, or a dual interface mode card. In addition, the smart card IC 113 is conformed to such as ISO7816 standard, ISO/IEC14443 standard, ISO15693 standard, ISO/IEC18000 standard, ISO18185 standard, EMV standard, EMV Contactless standard, MIFARE standard or FELICA standard.

As indicated in FIG. 2, the code generator 114 is electrically connected to the security module 1131 and used for generating a code 1141. The code generator 114 may be integrated with one of the security module 1131 and the display circuit 111. In the present embodiment, the code generator 114 is integrated with the security module 1131. In another embodiment, the code generator 114 may be separately disposed instead of being integrated with the security module 1131 or the display circuit 111. Under such circumstances, the code generator 114 is electrically connected to at least one of the security module 1131 and the display circuit 111.

The code 1141 is such as a one-time code. Based on the rules set at the time when the card is issued, the code 1141 is different when generated at different time, hence improving the security of the smart card 100. The rules are such as: generating a predetermined code at a predetermined transaction time. For example, a predetermined code “12345” is generated at a predetermined time period from 14:05 to 14:10. In other embodiments, the code 1141 is not a one-time code, and may be a randomly generated code or a set of cyclic codes.

As indicated in FIG. 2, the flexible display 115 is connected to the display circuit 111. The flexible display 115 is used for displaying the code 1141, the transaction information and/or other information. The transaction information is such as transaction amount, balance and/or transaction time.

After the code 1141 is displayed, the user may input a displayed code 1141 to the input device 140. After the input device 140 receives the input of the code 1141, the reader 130 transmits the inputted code 1141 and the security verification information 1132 to the confirmation server 160 to confirm whether the inputted code 1141 and the security verification information 1132 are correct. When the inputted code 1141 and the security verification information 1132 both are correct, this indicates that the current communication or transaction is an expected one and is thus permitted to complete.

In the present embodiment, the user needs to manually input the code 1141 so as to proceed to subsequent steps. That is, the process of communication or transaction is not entirely by the smart card 100 in an automatic manner, so as to avoid unexpected transaction.

As indicated in FIG. 2, the input device 140 is such as an external input device. For example, the input device 140 may be connected to the reader 130 in a cabled or wireless manner. The input device 140 is such as a keyboard, a voice input device, a button device, a mouse or other input devices. The button device is such as a single-key button device, and the voice input device is such as a microphone.

The smart card 100 further transmits a transaction data (such as the transaction amount, balance and/or transaction time) to the reader 130, which then transmits the transaction data to the confirmation server 160. The smart card 100 may synchronously or separately (such as asynchronously) transmits at least two of the transaction data, the inputted code 1141 and the security verification information 1132 to the reader 130. The reader 130 also may synchronously or separately (such as asynchronously) transmits at least two of the transaction data, the inputted code 1141 and the security verification information 1132 to the confirmation server 160.

The card body 120 encapsulates the flexible electronic system 110. The card body 120 comprises a first card body 121 and a second card body 122. The first and second card bodies 121 and 122 possess flexibility and are made from such as polyvinyl chloride (PVC).

The first and second card bodies 121 and 122 are bonded with an adhesive material, and the gap between the first and second card bodies 121 and 122 and the flexible electronic system 110 is interposed with an adhesive material. Examples of adhesive materials include thermosetting adhesives or a mixture of several cured adhesives. The first and second card bodies 121 and 122 can be windowed or grooved in advance, and the first and second card bodies 121 and 122 can be formed by a single- or multi-layered structure. In addition, the first and second card bodies 121 and 122 can be pre-casted and then formed by way of injection molding. Or, the first and second card bodies 121 and 122 are directly laminated. The first and second card bodies 121 and 122 are such as stacked together. The card body disposed on the side with display function is light permeable and is realized by such as a full-transparent or a semi-transparent card body for allowing the light emitted by the flexible display 115 of the flexible electronic system 110 to pass through.

Patterns can be formed on the surfaces or inner layers of the first and second card bodies 121 and 122 by way of printing or thermo-transferring. The surfaces of the first and second card bodies 121 and 122 can be coated with a protection layer to protect the card body or the pattern printed thereon. The first and second card bodies 121 and 122 are preferably but not restrictively bonded by the cold pressing technology using such as thermosetting adhesive, electromagnetic wave cured adhesive, or a mixture of two or more than two cured adhesives. Since the operating temperature is lower than 105 degrees Celsius, the parts of the flexible electronic system 110 will not be overheated and damaged.

As indicated in FIG. 2, the smart card 100 further comprises a power generator 116 connected to the display circuit 111. The power generator 116 receives a radio signal WL via the communication interface 112, and accordingly generates a power (not illustrated) for the internal elements of the smart card 100 by way of such as electro-magnetic induction. The radio signal WL is such as a radio frequency signal or a radio signal within other frequency ranges.

The power generator 116 further comprises a DC/DC converter (not illustrated) which converts a direct current (DC) into a working voltage required by the display circuit 111.

The display circuit 111 comprises a display driver 1111 and a display controller 1112. The display driver 1111 is connected to the flexible display 115 for driving the flexible display 115. The display controller 1112 connects the display driver 1111 and the smart card IC 1 36 and is used for controlling the display driver 1111. The power require by the display controller 1112 can be provided by the power generator 116 for enabling the flexible display 115 to display normal frames.

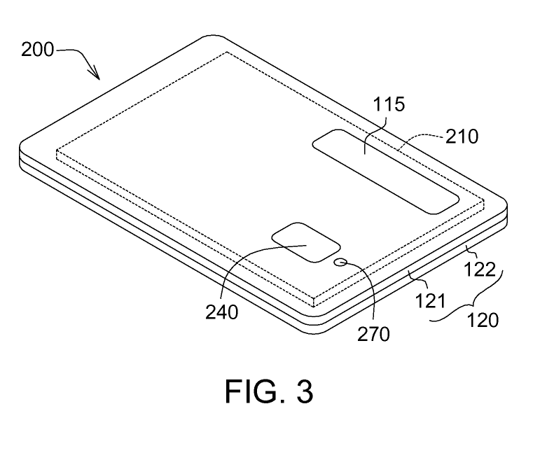

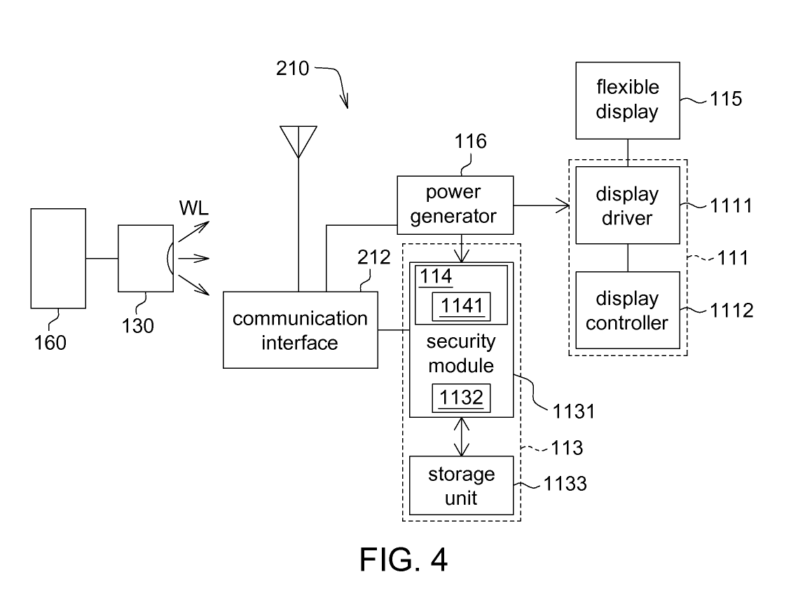

Referring to FIGS. 3 and 4. FIG. 3 shows an external view of a smart card according to another embodiment of the invention. FIG. 4 shows a function block diagram of the smart card of FIG. 3.

As indicated in FIG. 3, the smart card 200 comprises a flexible electronic system 210, a card body 120 and an input device 240. The card body 120 encapsulates the flexible electronic system 210. The input device 240, such as a switch, is electrically connected to the flexible electronic system 210.

As indicated in FIGS. 3 and 4, after the input device 240 is triggered, the security module 1131 of the flexible electronic system 210 transmits the security verification information 1132 to the reader 130 through the wireless communication interface 212. The reader 130 then transmits the security verification information 1132 to the confirmation server 160 to confirm whether the security verification information 1132 is correct.

As indicated in FIG. 4, the flexible electronic system 210 comprises a wireless communication interface 212 and a security module 1131. The wireless communication interface 212 performs a wireless communication with the reader 130. The wireless communication interface 212 may communicate with the reader 130 by using various wireless communication technologies, which are not restricted in the present embodiment.

As indicated in FIG. 4, the smart card 200 further comprises a code generator 114 electrically connected to the security module 1131 and used for generating a code 1141. In an embodiment, the smart card 200 may omit the code generator 114.

As indicated in FIG. 4, the smart card 200 further comprises an indication element 270 electrically connected to the code generator 114. After the code 1141 is generated, the indication element 270 of the smart card 100 outputs an indication signal. The indication element 270 is such as a light emitting element or a voice generator. After seeing or hearing the indication signal (the light or the voice) of the indication element 270, the user will know that the code 1141 is already generated. In an embodiment, the smart card 200 may omit the indication element 270.

In another embodiment, the reader 130 comprises an indication element (not illustrated). The indication element of the reader 130 is similar to the indication element 270. Before the input device 240 of the smart card 100 is triggered, the indication element 270 of the reader 130 outputs an indication signal. Thus, after seeing or hearing the indication signal of the indication element of the reader 130, the user will know that the code 1141 is already generated.

As indicated in FIG. 4, the smart card 200 further comprises a flexible display 115 used for displaying the code 1141. After the input device 240 is triggered, the reader 130 transmits the displayed code 1141 to the confirmation server 160 to confirm whether the displayed code 1141 is correct. In an embodiment, the smart card 100 may omit the flexible display 115.

As indicated in FIG. 4, the smart card 200 further comprises a display circuit 111 electrically connected to the flexible display 115. The code generator 114 is integrated with one of the security module 1131 and the display circuit 111. In another embodiment, the code generator 114 may be separately disposed instead of being integrated with the security module 1131 and/or the display circuit 111. Under such circumstances, the code generator 114 is still electrically connected to the security module 1131. In an embodiment, the smart card 200 may omit the flexible display 115 and the display circuit 111.

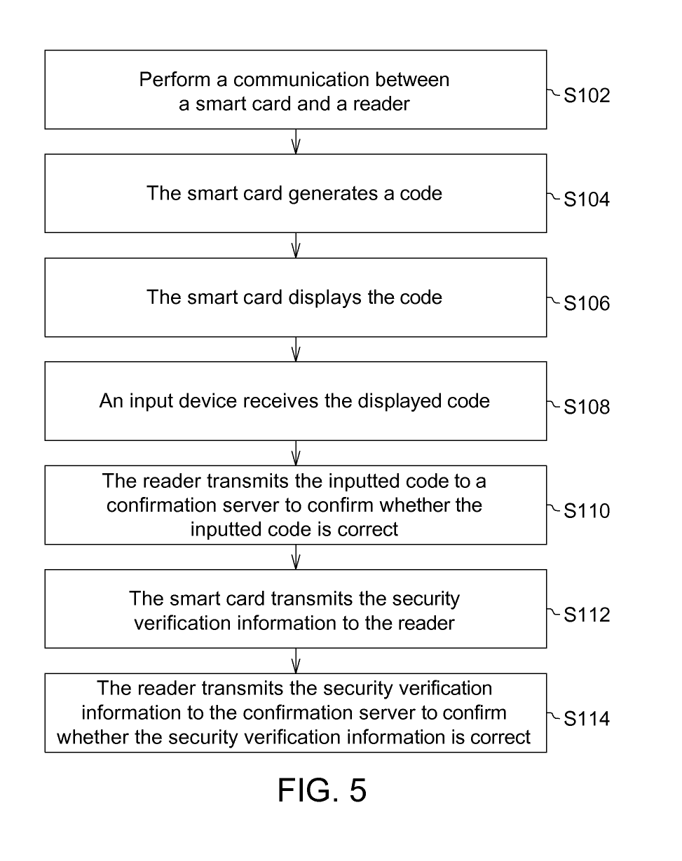

Referring to FIG. 5, a flowchart of a communication method of a smart card according to an embodiment of the invention is shown. The smart card 100 of FIG. 1 is exemplified below.

In step S102, the smart card 100 communicates with the reader 130. In the present step, the smart card 100 may get close to the reader 130 to be sensed by the reader 130.

In step S104, the code generator 114 of the smart card 100 generates a code 1141.

In step S106, the flexible display 115 of the smart card 100 is used for displaying the code 1141.

In step S108, the input device 140 receives the input of the displayed code 1141, wherein the input device 140 is electrically connected to the reader 130.

Before step S108, the input device 140 waits for the input of the displayed code 1141, and the system will not precede to subsequent steps before the displayed code 1141 is inputted to the input device 140. In greater details, the code 1141 received by the input device 140 is inputted by the user manually. The non-automatic input process prevents the smart card from incurring unexpected communication or transaction between the smart card 100 and the reader 130.

Besides, the user sees the displayed code 1141 of the smart card 100 clearly so as to input the code conveniently.

In step S110, the reader 130 transmits the inputted code 1141 to the confirmation server 160 to confirm whether the inputted code 1141 is correct.

In step S112, the communication interface 112 of the smart card 100 transmits security verification information 1132 to the reader 130.

Before step S112, the smart card 100 may be placed on the reader 130 for communicating with the reader 130. After the smart card 100 is placed on the reader 130, the reader 130 requests the smart card 100 to provide the security verification information 1132.

In step S114, the reader 130 transmits the security verification information 1132 to the confirmation server 160 to confirm whether the security verification information 1132 is correct.

The transaction is completed if the inputted code 1141 and the security verification information 1132 both are correct. After the transaction is completed, the flexible display 115 displays balance or other information of the transaction.

The above procedures of steps S102˜S114 are not for limiting the invention. The invention is exemplified by another embodiment below.

In another embodiment, the communication method of a smart card includes the following steps. In step S102, the smart card 100 is placed on the reader 130, and is not moved away from the reader 130 until the reader 130 transmits the security verification information 1132 to the confirmation server 160 (step S114). Thus, the smart card 100 is still placed on the reader 130 in step S112. In the present embodiment, when the smart card 100 is placed on the reader 130, the reader 130 requests the smart card 100 to provide the code 1141 and the security verification information 1132.

The sequence in providing the code 1141 and the security verification information 1132 is not for limiting the present embodiment of the invention. For example, the reader 130 may synchronously request the smart card 100 to provide the code 1141 and the security verification information 113; or, the reader 130 may request the smart card 100 to provide one of the code 1141 and the security verification information 1132 first and then provide the other one of the code 1141 and the security verification information 1132 next. In an embodiment, steps S104˜S110 may be performed after steps S112˜S114. Under such circumstances, the reader 130 requests the smart card 100 to provide the security verification information 1132 first and then requests the smart card 100 to provide the code 1141 next.

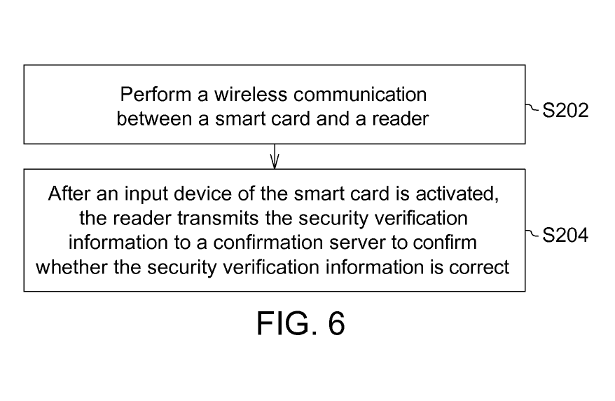

Referring to FIG. 6, a flowchart of a communication method of a smart card according to another embodiment of the invention is shown. The smart card 200 of FIG. 2 is exemplified below.

In step S202, the smart card 200 communicates with the reader 130. In the present step, the smart card 200 may get close to the reader 130 to be sensed by the reader 130 for communicating with the reader 130.

In step S204, after the input device 240 of the smart card 200 is triggered, the smart card 200 transmits security verification information 1132 to the reader 130, which then transmits the security verification information 1132 to the confirmation server 160 to confirm whether the security verification information 1132 is correct. That is, the transaction is completed if the input device 240 is triggered and the security verification information 1132 is correct, but the invention is not limited thereto.

In addition, the reader 130 may request the smart card 200 to provide the security verification information 1132. For example, before step S204 is performed, after the smart card 200 is placed on the reader 130, the reader 130 requests the smart card 200 to provide the security verification information 1132 to verify transaction security.

The system will not proceed to subsequent steps before the input device 240 is triggered. In greater details, the input device 240 is manually triggered by the user. The non-automatic activation process prevents the smart card 200 from incurring any unexpected communication or transaction between the smart card 200 and the reader 130.

In another embodiment, the communication method of a smart card further comprises several steps. For example, the code generator 114 of the smart card 200 generates a code 1141. Next, the communication interface 212 of the smart card 200 transmits the code 1141 to the reader 130. Then, after the input device 240 of the smart card 200 is triggered, the smart card 200 transmits the code 1141 to the reader 130, which then transmits the code 1141 to the confirmation server 160 to confirm whether the code 1141 is correct. The transaction is completed if the input device 240 is triggered, the code 1141 is correct and the security verification information 1132 is correct. Besides, the order in transmitting the code 1141 and the security verification information 1132 to the reader 130 is not for limiting the invention.

In another embodiment, the communication method of a smart card further comprises several steps. For example, the flexible display 115 of the smart card 200 is used for displaying the code 1141. Next, the smart card 200 transmits the code 1141 to the reader 130. Then, after the input device 240 of the smart card 200 is triggered, the smart card 200 transmits the displayed code 1141 to the reader 130, which then transmits the displayed code 1141 to the confirmation server 160 to confirm whether the displayed code 1141 is correct. The transaction is completed if the input device 240 is triggered, the displayed code 1141 is correct and the security verification information 1132 is correct. Besides, the order in transmitting the code 1141 and the security verification information 1132 to the reader 130 is not for limiting the invention.

In another embodiment, the communication method of a smart card further comprises several steps. For example, after the code 1141 is generated, the indication element 270 of the smart card 200 outputs an indication signal to inform the user that the code 1141 is already generated.

In another embodiment, the smart card 200 may omit the indication element 270. Under such circumstances, the user may trigger the input device 240 as the smart card 200 gets close to the reader 130. In general, once the reader 130 senses the smart card 200, the smart card 200 may communicate with the reader 130.

In another embodiment, the communication method of a smart card further comprises several steps. For example, before the input device 240 of the smart card 200 is triggered, the indication element (not illustrated) of the reader 130 outputs an indication signal to inform the user that the code 1141 is already generated. The indication signal is similar to that of the indication element 270.

The application of the communication method of the invention is exemplified by the application in transaction. However, the application of the communication method of the invention is not limited thereto, and can also be used in the fields other than transaction. The communication method of the invention may be used in any applications in which the communication between the smart card and the reader requires a non-automatic confirmation process before the smart card proceeds to subsequent steps.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A smart card, comprising:
a flexible electronic system, comprising:
a display circuit;
a communication interface used for communicating with a reader;
a security module used for transmitting security verification information to the reader through the communication interface;
a code generator electrically connected to the security module and used for generating a code; and
a flexible display connected to the display circuit for displaying the code; and
a card body used for encapsulating the flexible electronic system;
wherein, after an input device receives the inputted code, the reader transmits the inputted code and the security verification information to a confirmation server to confirm whether the inputted code and the security verification information are correct.

2. The smart card according to claim 1, wherein the code is a one-time code.

3. The smart card according to claim 1, wherein the code generator is integrated with one of the security module and the display circuit.

4. The smart card according to claim 1, wherein the input device is a keyboard, a voice input device or a button.

5. A smart card, comprising:
a flexible electronic system, comprising:
a wireless communication interface used for performing wireless communication with a reader;
a security module used for transmitting security verification information to the reader through the wireless communication interface; and
a card body used for encapsulating the flexible electronic system; and
an input device electrically connected to the flexible electronic system, wherein after the input device is triggered, the security module transmits the security verification information to the reader, which then transmits the security verification information to a confirmation server to confirm whether the security verification information is correct.

6. The smart card according to claim 5, further comprising:
a code generator electrically connected to the security module and used for generating a code.

7. The smart card according to claim 6, further comprising:
a flexible display used for displaying the code;
wherein, after the input device is triggered, the reader transmits the displayed code to the confirmation server to confirm whether the displayed code is correct.

8. The smart card according to claim 7, wherein the flexible electronic system further comprises:
a display circuit electrically connected to the flexible display;
wherein, the code generator is integrated with one of the security module and the display circuit.

9. The smart card according to claim 5, further comprising:
an indication element electrically connected to the code generator, wherein the indication element of the smart card outputs an indication signal after the code is generated.

10. The smart card according to claim 5, wherein the reader comprises an indication element, and the indication element of the reader outputs an indication signal before the input device of the smart card is triggered.

11. A communication method of a smart card, wherein the method comprises:
performing a communication between a smart card and a reader;
the smart card generating a code;
the smart card displaying the code;
an input device receiving the input of the displayed code, wherein the input device is electrically connected to the reader;
the reader transmitting the inputted code to a confirmation server to confirm whether the inputted code is correct;
the smart card transmitting security verification information to the reader; and
the reader transmitting the security verification information to the confirmation server to confirm whether the inputted code and the security verification information are correct.

12. The communication method according to claim 11, further comprising:
the reader requesting the smart card to provide at least one of the code and the security verification information.

13. A communication method of a smart card, wherein the method comprises:
performing a wireless communication between a smart card and a reader;
After an input device of the smart card is triggered, the smart card transmits the security verification information to the reader, which then transmits the security verification information to a confirmation server to confirm whether the security verification information is correct.

14. The communication method according to claim 13, further comprising:
the smart card generating a code; and
After the input device of the smart card is triggered, the smart card transmits the code to the reader, which then transmits the code to the confirmation server to confirm whether the code is correct.

15. The communication method according to claim 13, further comprising:
the reader requesting the smart card to provide the security verification information.

16. The communication method according to claim 14, further comprising:
the reader requesting the smart card to provide at least one of the code and the security verification information.

17. The communication method according to claim 13, further comprising:
the smart card displaying the code; and
After the input device is triggered, the reader transmits the displayed code to the confirmation server to confirm whether the displayed code is correct.

18. The communication method according to claim 13, wherein the smart card comprises an indication element, and the communication method further comprises:
the indication element of the smart card outputting an indication signal after the code is generated.

19. The communication method according to claim 13, wherein the reader comprises an indication element, and after the wireless communication between the smart card and the reader is performed, the communication method further comprises:
the reader outputting an indication signal.

20. The communication method according to claim 13, wherein the code is a one-time code.
